(19) United States
(12) Patent Application Publication
(10) Pub. No.: US 2024/0157255 A1
(43) Pub. Date: May 16, 2024

(54) Fantasy Football Game System and Method of Playing Fantasy Football

(71) Applicant: Joshua Albright, Wallis, TX (US)

(72) Inventor: Joshua Albright, Wallis, TX (US)

(21) Appl. No.: 18/504,530

(22) Filed: Nov. 8, 2023

Related U.S. Application Data
(60) Provisional application No. 63/424,506, filed on Nov. 11, 2022.

(51) Int. Cl. A63F 13/828; A63F 13/65

(52) U.S. Cl. CPC A63F 13/828; A63F 13/65

(57) ABSTRACT

A fantasy football game system and method are disclosed. The system operates as a client-server system and gathers real-time player projections, past performances, and rankings to provide comprehensive insights into player performance. Using client devices and installed browser and application, participants draft their fantasy teams, adhering to salary cap constraints and player limits. The system automates the selection of optimal lineups, obviating the need for manual adjustments. Additionally, the system dynamically adjusts player salaries and projections, responding to changes in player performance and availability. The system incorporates a scoring engine and different rules for calculating scores for players and teams and the system is adaptable to various sports, enhancing its appeal to a broader range of sports enthusiasts.

### CROSS-REFERENCE TO RELATED APPLICATION

The present application claims priority to, and the benefit of, U.S. Provisional Application No. 63/424,506, which was filed on Nov. 11, 2022, and is incorporated herein by reference in its entirety.

### FIELD OF THE INVENTION

The present invention generally relates to the field of fantasy sports. More specifically, the present invention relates to a novel fantasy game for constructing fantasy football rosters, designed to address the challenges and frustrations commonly associated with standard fantasy football games. The fantasy game includes data-driven projections, customizable scoring systems, and personalized adjustments to create balanced rosters without the need for in-season trades, waiver wire pickups, or manual lineup changes. Accordingly, the present disclosure makes specific reference thereto. Nonetheless, it is to be appreciated that aspects of the present invention are also equally applicable to other like applications, devices, and methods of manufacture.

### BACKGROUND

By way of background, fantasy sports such as fantasy football have become a widespread and immensely popular form of entertainment around the globe. In a fantasy sport, participants draft and manage their virtual sports teams based on real-life sports players. For example, in the USA, participants draft and manage their virtual football teams based on real-life NFL players. Conventionally, to play fantasy football, participants first draft a team of players from a pool of all players in the league. The draft order is typically determined by a random drawing. Once teams are drafted, participants compete against each other each week by setting their starting lineups. Commonly, fantasy football is season-long. In a season-long league, participants compete against each other over the course of the entire NFL season.

However, in conventional fantasy football, participants often have little control over their draft positions, which can significantly influence the quality of their initial roster. This can also lead to perceived inequalities in team strength. Human biases, including personal preferences for certain players and teams, can influence draft decisions and trade negotiations, creating an inherent bias in the game. Also, the competitive landscape in standard fantasy football is uneven, with some teams enjoying advantages in terms of draft position, roster depth, or favorable transactions. Further, in traditional fantasy football, participants manually set their weekly lineups, which can be time-consuming and may lead to suboptimal choices, especially when dealing with injuries or bye weeks. Individuals desire an improved football fantasy which provides a fair and competitive environment for all participants.

Therefore, there exists a long felt need in the art for an improved fantasy game. Additionally, there is a long felt need in the art for a novel fantasy football game that combines a unique set of rules, including automated weekly roster optimization and a restriction on player changes. Moreover, there is a long felt need in the art for a fantasy football game that offers the flexibility to adapt to changing circumstances during the season while considering the impact of injuries and suspensions on player values. Further, there is a long felt need in the art for a fantasy game that provides a dynamic and strategic fantasy football experience. Furthermore, there is a long felt need in the art for a fantasy game that uses real player data to automate roster management, adjustments, and reward allocation. Finally, there is a long felt need in the art for a fantasy football game that encourages participants to build versatile rosters, strategically assign players to positions, and plan for multi-week performance, resulting in a dynamic and competitive fantasy football experience.

The subject matter disclosed and claimed herein, in one embodiment thereof, comprises a method for operating a fantasy sports game. The method comprising the steps of gathering player projections, past performances, rankings, and related data from a plurality of sources to provide insights into the expected performance of real players, allowing participants to draft fantasy teams with real players, applying salary cap constraints and player limits in a roster, automatically selecting optimal lineups for participants based on gathered player data and obviating manual roster adjustments, automatically adjusting player salaries and projections based on performance and availability and rewarding participants with the highest-scoring fantasy teams at the end of a season. The method is operated by a computer implemented game system which includes a server and one or more connected client devices wherein the participants access the game using a browser and a mobile application.

In this manner, the game system and associated game method of the present invention accomplish all of the forgoing objectives and provide users with a software application or website that offers a unique fantasy football game for sports fans which provides automated lineup selection and player adjustments, reducing the time and effort required from participants. The system utilizes real-time player data and projections, enhancing the accuracy and relevance of player performance assessments. The game rules are enforced automatically, providing a clear and transparent framework for all participants.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fantasy football game system. The system further comprising a server connected to a plurality of client devices, the server includes an identity management module adapted for granting authorized access to participants. A player statistics database is configured to collect, store, and provide real-time data and statistics for real players. A scoring engine is implemented on the server to calculate and update scores for participants' fantasy teams based on player performance, with the scoring engine applying the game's scoring rules and algorithms to determine points earned by each player and calculate team scores. A draft system is integrated into the server for conducting player drafts. A game rules engine is configured to enforce specific rules and settings of the fantasy sports game. A transactions module is incorporated into the server to facilitate player trading and transactions.

In yet another embodiment, each client device is equipped with a web browser and/or a software application, enabling participants to draft and manage fantasy teams and participate in the fantasy sports game.

In yet another embodiment, a method for operating a fantasy sports game system is described. The method includes the steps of establishing a client-server architecture where a centralized or distributed server is connected to a plurality of client devices, handling user registration, login, and account management, granting authorized access to participants to utilize the system's functionalities, collecting and storing real-time data and statistics for real players, selecting players to form a team from a roster, calculating and updating scores for participants' fantasy teams based on player performance, and facilitating player trading and transactions.

In yet another aspect, a method for operating a fantasy sports game is described. The method comprising the steps of gathering player projections, past performances, rankings, and related data from a plurality of sources to provide insights into the expected performance of real players, allowing participants to draft fantasy teams with real players, applying salary cap constraints and player limits in a roster, automatically selecting optimal lineups for participants based on gathered player data and obviating manual roster adjustments, automatically adjusting player salaries and projections based on performance and availability and rewarding participants with the highest-scoring fantasy teams at the end of a season.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flow chart depicting the steps involved in the fantasy football game of the present invention in accordance with the disclosed architecture;

FIG. 2 illustrates a block diagram showing components of the novel fantasy football game of the present invention in accordance with the disclosed architecture;

FIG. 3 illustrates a flow chart depicting a method of scoring and preparing weekly rosters by the fantasy football game system in accordance with the disclosed architecture;

FIG. 4 illustrates an exemplary interface displayed by the system for displaying ranking of different fantasy teams in accordance with one embodiment of the present invention;

FIG. 5 illustrates an exemplary interface displaying scores of individual players of a roster of a participant in accordance with one embodiment of the present invention; and

FIG. 6 illustrates an exemplary scoring table displaying a team score calculator for various offense and defense.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved fantasy game. Additionally, there is a long felt need in the art for a novel fantasy football game that combines a unique set of rules, including automated weekly roster optimization and a restriction on player changes. Moreover, there is a long felt need in the art for a fantasy football game that offers the flexibility to adapt to changing circumstances during the season while considering the impact of injuries and suspensions on player values. Further, there is a long felt need in the art for a fantasy game that provides a dynamic and strategic fantasy football experience. Furthermore, there is a long felt need in the art for a fantasy game that uses real player data to automate roster management, adjustments, and reward allocation. Finally, there is a long felt need in the art for a fantasy football game that encourages participants to build versatile rosters, strategically assign players to positions, and plan for multi-week performance, resulting in a dynamic and competitive fantasy football experience.

The present invention, in one exemplary embodiment, is a fantasy football game system. The system features a server connected to a plurality of client devices, the server includes an identity management module adapted for granting authorized access to participants. A player statistics database is configured to collect, store, and provide real-time data and statistics for real players. A scoring engine is implemented on the server to calculate and update scores for participants' fantasy teams based on player performance, with the scoring engine applying the game's scoring rules and algorithms to determine points earned by each player and calculate team scores. A draft system is integrated into the server for conducting player drafts. A game rules engine is configured to enforce specific rules and settings of the fantasy sports game. A transactions module is incorporated into the server to facilitate player trading and transactions.

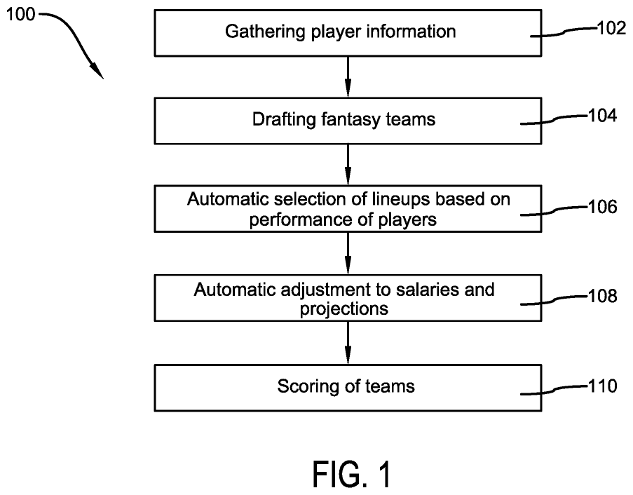

Referring initially to the drawings, FIG. 1 illustrates a flow chart depicting the steps involved in the fantasy football game of the present invention in accordance with the disclosed architecture. The fantasy football game 100 of the present invention is designed to allow participants or users to draft and manage their fantasy teams by selecting real players such as NFL players. The fantasy football game 100 uses data-driven projections with personalized adjustments to create a balanced and competitive fantasy football roster. Also, the fantasy football 100 is hosted on a dedicated software application or website and participants can access the game, draft their teams, and track their progress through the application or website.

More specifically, for playing the fantasy game 100, in the first step 102, player projections, past performances, rankings and more are gathered from different sources. The gathered data is used to provide an insight into the expected performance of players during the upcoming season. The sources can be paid databases, authorized sources of football organizations and databases maintained by the fantasy football game organizers.

In the second step 104, the participants draft and set up their fantasy football teams. This can include selecting real NFL players to fill different positions on the roster. The positions commonly include quarterbacks, running backs, wide receivers, tight ends, kickers, and team defenses. It will be apparent to a person skilled in the art that the present invention can be extended to any sport including but not limited to cricket, soccer, golf, basketball, volleyball, badminton, hockey, ice hockey, wrestling and more. During formation of the rosters, a predetermined salary cap and restriction on number of players in a roster are applied. The salary cap represents the total salary cost of the players on the roster. The restrictions allow participants to make strategic decisions when choosing players.

In the third step 106, each week or at a predetermined periodic gap, the best lineup or team is automatically selected for each participant. The team for a participant is auto selected from the players selected on the roster by the participant and includes the players data gathered by the fantasy game system as described in the first step 102. An advantage of the automated fantasy football game 100 is that manual roster adjustments are not required.

In the fourth step 108, automatic adjustments to the salaries and projections of players are done to make automatic adjustments in the rosters of participants. Accordingly, as an example, if a player is injured or suspended and/or if their performance declines, their projections decrease, and their salary is reduced. Conversely, the projections for other players may slightly increase due to the shift in player availability, performance, and opportunities. Finally, in the step 110, at the end of the season or at predetermined stages of a season, participants whose team score highest are automatically selected and rewarded.

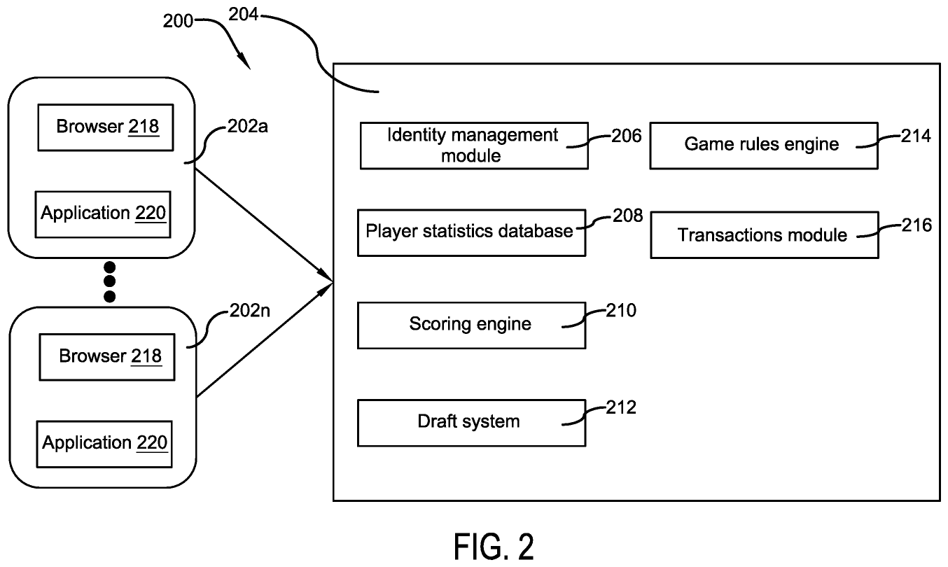

FIG. 2 illustrates a block diagram showing components of the novel fantasy football game of the present invention in accordance with the disclosed architecture. The fantasy football game system 200 is preferably implemented as a client-server system where a plurality of participants functions through client devices 202a-n (hereinafter, referred to as 202) connected to a server 204. The game system 200 may include a centralized server or a distributed server depending on the design requirements of the system 100. The server 204 includes an identity management module 206 adapted to handle user registration, login, and account management. The module 206 is responsible for providing authorized access to the participants of the functionalities offered by the fantasy game system 200.

A player statistics database 208 is configured to collect and store real-time data and statistics for real players such as NFL players. The data can include player performance, injury updates, past performance, and other relevant information used for scoring in the game. The server 204 may be connected to different sources for extracting player information for storage in the database 208. Player projections and rankings are also stored in the statistics database 208.

A scoring engine 210 is adapted to calculate and update scores for the fantasy teams of participants based on the performance of the players on their rosters. The scoring engine 210 applies the game's scoring rules and algorithms to determine points earned by each player to calculate score for the teams. A draft system 212 of the server 204 is configured for conducting the player draft. The draft system 212 helps in roster formation ensuring that the draft process is fair and follows the rules of the game. In some embodiments, an auction draft may be used for selecting players in the fantasy sports game.

A game rules engine 214 is configured to enforce the specific rules and settings of the fantasy football game. Different rules such as predetermined salary cap for each player and each roster and total number of players in a roster are configured in the game rules engine 214. The scoring engine 210 works in conjunction with the games rule engine 214 for enforcing the rules.

A transactions module 216 allows manual and automatic trading or transactions of players. The transactions module 216 maintains trade proposals, records player transfers between teams, and maintains a transaction history. Only authorized trading and transactions are allowed by the transactions module 216 as per the game rules engine 214.

Each client device 202 can include a web browser 218 and/or a software application 220 for accessing functionalities offered by the system 200. The browser 218 and the application 220 are configured to perform and/or initiate various types of operations, activities, functions with respect to providing fantasy sports games.

It will be apparent to a person skilled in the art that the game system 200 can include a plurality of different types of components, devices, modules, processes, systems, and the like, which, for example, may be implemented and/or instantiated via the use of hardware and/or combinations of hardware and software. According to different embodiments, different types of encryption/decryption techniques may be used to facilitate secure communications between devices in the fantasy game system 200 and/or other networks. Software and hardware of the fantasy football game system 200 described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, and the like.

It should be understood that the fantasy sports game can be provided, administered, and played on some or all of the computing devices, computerized data networks, client systems, server systems, networks including the Internet, and/or mobile devices and systems therefor. Various other suitable computing devices, clients, servers and/or networks can also be used alternatively or in addition to the foregoing items for the disclosed fantasy game. Such devices, servers, and networks can be used to provide “apps” and/or browsers that allow for fantasy game administration and play.

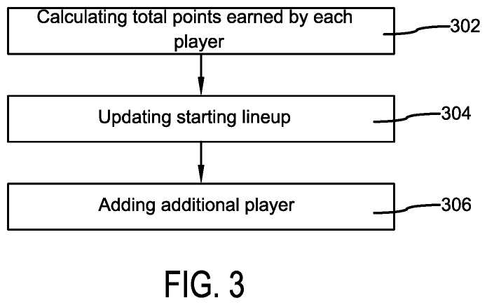

FIG. 3 illustrates a flow chart depicting a method of scoring and preparing weekly rosters by the fantasy football game system 200 in accordance with the disclosed architecture. Initially, after each sport week of a league such as NFL game week, the game system 200 calculates the total points earned by each player in the rosters based on their performance and the scoring system's parameters and weightages (Step 302). In some embodiments, team for the first week of a participant can be made manually by the participant or can be automatically generated by the system 200.

At the beginning of the next sport week, the system 200 automatically updates the starting lineup of each participant (Step 304). The updates are done based on availability, performance, and position of the players of the roster and are aimed at maximizing the potential points. For example, if a player not included in the starting lineup outperforms a starter, the system may automatically substitute the players.

In the next step, in the present embodiment, the system may allow the participants to add players who are not on the initial roster. The players are added for a specified fee, allowing them to adapt to changing circumstances (Step 306).

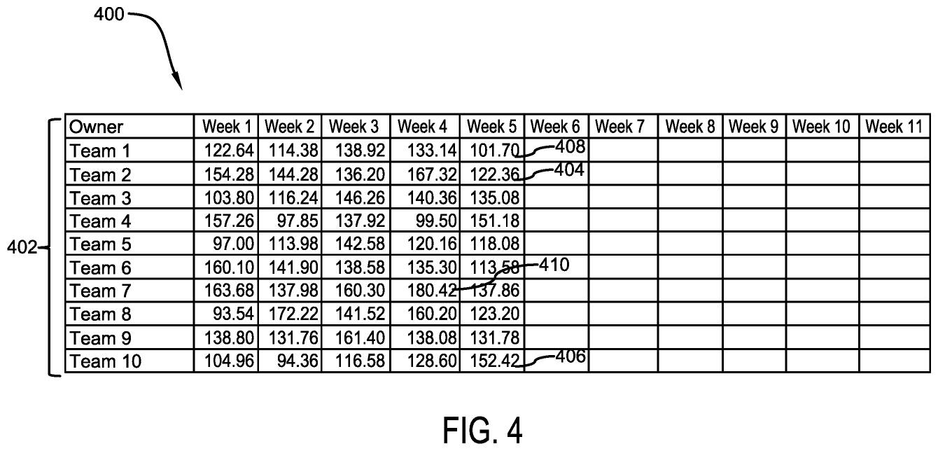

FIG. 4 illustrates an exemplary interface displayed by the system 200 for displaying ranking of different fantasy teams in accordance with one embodiment of the present invention. As illustrated, the interface 400 displays different teams 402 and corresponding scores 404 of each team per week. It should be noted that one participant can register multiple fantasy teams. The interface 400 highlights highest score for each week as highlighted via numeral 406 for Week 1. Similarly, the numeral 408 highlights the lowest score for a week. The highest score 410 of the season is highlighted in a different color and can be used as a benchmark by participants. In the present embodiment, any score can be selected for displaying the corresponding playing team along with the corresponding positions of players in the team. Further, the teams of other participants are visible to participants based on role-based access and on authorization by owner of the team.

In one embodiment of the present invention, a roster that can be prepared by participants can include two quarterbacks (QB), four running backs (RB), five wide receivers (WR), three tight ends (TE), four flex players (FLEX), two kickers (KI) and three defensive players (D). Any other positions may also be included in the roster. Further, the rosters of the fantasy football game of the present invention can include positional overlaps, wherein a player can contribute to multiple positions simultaneously. For example, a player who excels in both rushing and receiving can be utilized in both running back and wide receiver positions, optimizing roster versatility and improvement in scoring of the team.

Table 1 below shows an exemplary scoring system used in the fantasy game of the present invention. It is to be appreciated that other descriptions and point scores can be included. For example, for Rushing Offense, a fumble could include −2 points.

TABLE 1
Passing Offense:

| Passing Yards | 1 point per 25 passing yards | |
|---|---|---|
| Passing Touchdowns | 6 | Points |
| Interceptions Thrown | −2 | Points |
| Two-Point Conversions (Passing) | 2 | Points |

Rushing Offense:

| Rushing Yards | 1 point per 10 rushing yards | |
|---|---|---|
| Rushing Touchdowns | 6 | Points |
| Two-Point Conversions (Rushing) | 2 | Points |

Receiving Offense:

| Receiving Yards | 1 point per 10 receiving yards | |
|---|---|---|
| Receiving Touchdowns | 6 | Points |
| Two-Point Conversions (Receiving) | 2 | Points |

Kicking:

| | | |
|---|---|---|
| Field Goals Made (0-39 yards) | 4 | Points |
| Field Goals Made (40-49 yards) | 6 | Points |
| Field Goals Made (50+ yards) | 8 | Points |

Defense:

| | | |
|---|---|---|
| Defensive Touchdowns | 6 | Points |
| Safeties | 5 | Points |
| Fumbles Recovered | 2 | Points |
| Interceptions | 2 | Points |

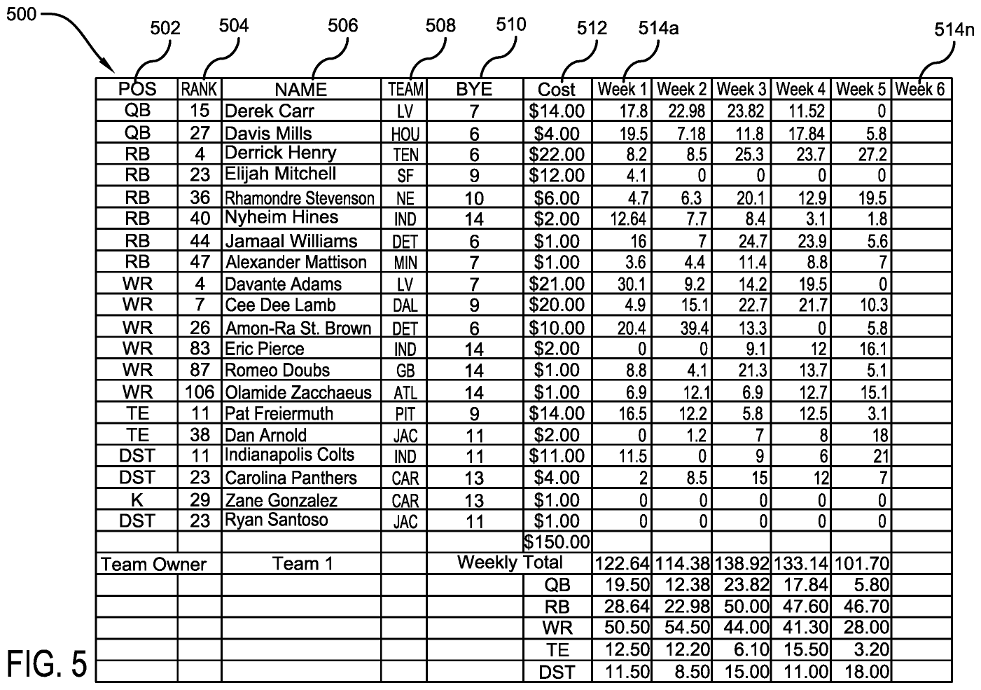

FIG. 5 illustrates an exemplary interface displaying scores of individual players of a roster of a participant in accordance with one embodiment of the present invention. As illustrated, the Position column 502 represents the position of the players and the Rank column 504 represents the rank of the player in the corresponding position. The Name column 506 represents the player name and the Team column 508 represents the team name. For each player, the Bye week 510 represents the BYE week of the player, wherein the roster is automatically updated to replace the player who has the Bye week.

Cost/Salary of each player is included in the Cost column 512 and score for each player is recorded per week in the Columns 514a-n. It will be appreciated that the score and the ranks are automatically calculated by the game system 100 and is used for ranking fantasy teams. The team with maximum score/points is declared as the winner.

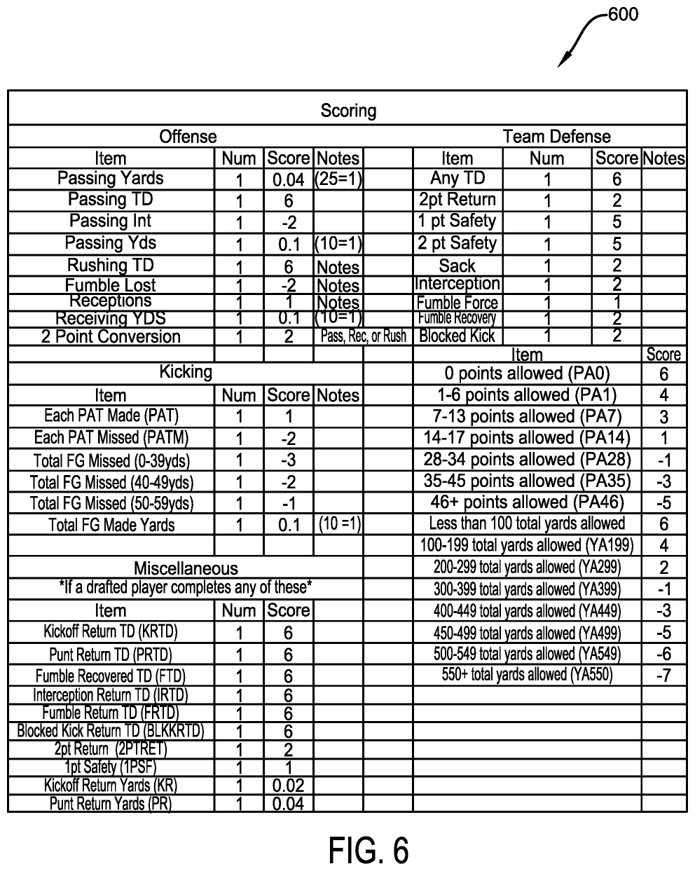

FIG. 6 illustrates an exemplary interface displaying scoring 600 of a team based on various offense, kicking, defense, and miscellaneous plays occurring in a football game in accordance with another exemplary embodiment of the present invention. Offense scoring can include passing yards, passing touchdowns, passing interceptions, rushing yards, rushing touchdowns, fumbles lost, receptions, receiving yards, 2-point conversions, et. al. Kicking scoring can include points after touchdown (PAT) made, PAT missed, field goals made, field goals missed, total field goal yards made, et. al. Defense scoring can include defensive touchdowns, two-point returns, safeties, sacks, interceptions, fumbles forced, fumbles recovered, blocked kicks, points allowed, total yards allowed, et. al. Miscellaneous scoring can include points for kickoff return touchdowns, punt return touchdowns, fumbles recovered for touchdown, interceptions returned for touchdown, fumbles returned for touchdown, blocked kick returned for touchdown, two-point return, safety, kickoff return total yards, punt return total yards, et. al.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fantasy football game system”, “fantasy game system”, “game system”, and “system” are interchangeable and refer to the fantasy football game system 200 of the present invention. Similarly, as used herein, “fantasy football game”, “fantasy football”, “fantasy game” and “game” are interchangeable and refer to the fantasy football game 100 of the present invention.

Notwithstanding the forgoing, the fantasy football game 100 and the fantasy football game system 200 of the present invention can be of any suitable size and configuration as is known in the art without affecting the overall concept of the invention, provided that they accomplish the above stated objectives. One of ordinary skill in the art will appreciate that the fantasy football game 100 and the fantasy football game system 200 as shown in the FIGS. is for illustrative purposes only, and that many other configurations of the fantasy football game 100 and the fantasy football game system 200 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of playing a fantasy football game, the method comprising the steps of:
drafting a roster of players to form a first fantasy team, wherein said drafting includes using data-driven projections with personalized adjustments to create said fantasy team, and further wherein said data-driven projections are selected from the group consisting of a player projection, a past performance, and a ranking;
managing said roster of players;
applying said past performance of a most recent game to said data-driven projections, wherein a plurality of points are accumulated from categories selected from the group consisting of an offense, a kicking, a defense, and a miscellaneous; and
accumulating points for said offense from the group consisting of passing yards, passing touchdowns, passing interceptions, rushing yards, rushing touchdowns, fumbles lost, receptions, receiving yards, and 2-point conversions, wherein points accumulated for said passing yards, said passing touchdowns, said rushing yards, said rushing touchdowns, said receptions, said receiving yards, and said 2-point conversions include positive points and said interceptions and said fumbles include negative points.

2. The method of playing a fantasy football game of claim 1, wherein said data-driven projections selected from the group of sources consisting of a paid database, an authorized source of football organizations, and a database maintained by a fantasy football game organizer.

3. The method of playing a fantasy football game of claim 1, wherein said roster of players selected from the group consisting of NFL players to fill different positions for said fantasy team.

4. The method of playing a fantasy football game of claim 1, wherein said positions selected from the group consisting of one or more of a quarterback, a running back, a wide receiver, a tight end, a kicker, a flex player, and a defensive player.

5. The method of playing a fantasy football game of claim 1, wherein said personalized adjustments selected from the group consisting of a predetermined salary cap and a restriction on a number of players for said first fantasy team and said at least second fantasy team.

6. The method of playing a fantasy football game of claim 1, wherein said salary cap includes a total salary cost limit of said roster of players of said first fantasy team and said at least second fantasy team.

7. The method of playing a fantasy football game of claim 1, further comprising the step of: adjusting said roster of players at predetermined time intervals to form at least a second fantasy team during a season of play.

8. The method of playing a fantasy football game of claim 7, wherein said adjusting said roster of players includes removing players from said first fantasy team and adding other players to form said at least second fantasy team and maximizing a total point score of said roster of players.

9. The method of playing a fantasy football game of claim 1, further comprising the step of: accumulating points for said kicking selected from the group consisting of varying points for field goals made and missed at varying distances.

10. The method of playing a fantasy football game of claim 9, wherein points accumulated for said kicking includes points for PATs made and missed.

11. The method of playing a fantasy football game of claim 10, further comprising the step of: accumulating points for said defense selected from the group consisting of defensive touchdowns, two-point returns, safeties, sacks, interceptions, fumbles forced, fumbles recovered, blocked kicks, points allowed, and total yards allowed.

12. The method of playing a fantasy football game of claim 11, further comprising the step of: accumulating points for said miscellaneous selected from the group consisting of kickoff return touchdowns, punt return touchdowns, fumbles recovered for touchdown, interceptions returned for touchdown, fumbles returned for touchdown, blocked kick returned for touchdown, two-point return, safety, kickoff return total yards, and punt return total yards.

13. A method of playing a fantasy football game, the method comprising the steps of:
drafting a roster of players to form a first fantasy team, wherein said drafting includes using data-driven projections with personalized adjustments to create said fantasy team, and further wherein said data-driven projections are selected from the group consisting of a player projection, a past performance, and a ranking;
managing said roster of players;
adjusting said roster of players at predetermined time intervals to form at least a second fantasy team during a season of play, wherein said adjusting said roster of players includes removing players from said first fantasy team and adding other players to form said at least second fantasy team and maximizing a total point score of said roster of players;
applying said past performance of a most recent game to said data-driven projections, wherein a plurality of points are accumulated from categories selected from the group consisting of a passing offense, a rushing offense, a receiving offense, a kicking, and a defense;
selecting said positions from the group consisting of one or more of a quarterback, a running back, a wide receiver, a tight end, a kicker, a flex player, and a defensive player; and
selecting said personalized adjustments from the group consisting of a predetermined salary cap and a restriction on a number of players for said first fantasy team and said at least second fantasy team, wherein said salary cap includes a total salary cost limit of said roster of players of said first fantasy team and said at least second fantasy team.

14. The method of playing a fantasy football game of claim 13, wherein points accumulated for said passing offense includes points for passing yards, passing touchdowns, two-point passing conversions, and interceptions thrown, and further wherein said passing yards, said passing touchdowns, said receptions, said receiving yards, and said two-point passing conversions include positive points and said interceptions thrown include negative points.

15. The method of playing a fantasy football game of claim 13, wherein points accumulated for said rushing offense includes points for rushing yards, rushing touchdowns, two-point rushing conversions, and fumbles, and further wherein said rushing yards, said rushing touchdowns, and said two-point rushing conversions include positive points and said fumbles include negative points.

16. The method of playing a fantasy football game of claim 13, wherein points accumulated for said receiving offense includes points for receiving yards, receiving touchdowns, and two-point receiving conversions, and further wherein said receiving yards, said receiving touchdowns, and said two-point receiving conversions include positive points.

17. The method of playing a fantasy football game of claim 13, further comprising the step of: accumulating points for said kicking selected from the group consisting of varying points for field goals made and missed at varying distances.

18. The method of playing a fantasy football game of claim 13, further comprising the step of: accumulating points for said defense selected from the group consisting of defensive touchdowns, two-point returns, safeties, sacks, interceptions, fumbles forced, fumbles recovered, blocked kicks, points allowed, and total yards allowed.

19. A method of playing a fantasy football game, the method comprising the steps of:
drafting a roster of players to form a first fantasy team, wherein said drafting includes using data-driven projections with personalized adjustments to create said fantasy team, and further wherein said data-driven projections are selected from the group consisting of a player projection, a past performance, and a ranking;
managing said roster of players;
applying said past performance of a most recent game to said data-driven projections, wherein a plurality of points are accumulated from categories selected from the group consisting of an offense, a kicking, a defense, and a miscellaneous;
accumulating points for said offense from the group consisting of passing yards, passing touchdowns, passing interceptions, rushing yards, rushing touchdowns, fumbles lost, receptions, receiving yards, and 2-point conversions;
accumulating points for said kicking selected from the group consisting of varying points for field goals made and missed at varying distances, wherein points accumulated for said kicking further includes points for PATs made and missed;
accumulating points for said defense selected from the group consisting of defensive touchdowns, two-point returns, safeties, sacks, interceptions, fumbles forced, fumbles recovered, blocked kicks, points allowed, and total yards allowed; and
accumulating points for said miscellaneous selected from the group consisting of kickoff return touchdowns, punt return touchdowns, fumbles recovered for touchdown, interceptions returned for touchdown, fumbles returned for touchdown, blocked kick returned for touchdown, two-point return, safety, kickoff return total yards, and punt return total yards.

20. The method of playing a fantasy football game of claim 19 further comprising the steps of:
selecting said positions from the group consisting of one or more of a quarterback, a running back, a wide receiver, a tight end, a kicker, a flex player, and a defensive player;
adjusting said roster of players at predetermined time intervals to form at least a second fantasy team during a season of play, wherein said adjusting said roster of players includes removing players from said first fantasy team and adding other players to form said at least second fantasy team and maximizing a total point score of said roster of players; and
selecting said personalized adjustments from the group consisting of a predetermined salary cap and a restriction on a number of players for said first fantasy team and said at least second fantasy team, wherein said salary cap includes a total salary cost limit of said roster of players of said first fantasy team and said at least second fantasy team.
